(19) United States
(12) Patent Application Publication
(10) Pub. No.: US 2026/0361976 A1
(43) Pub. Date: Nov. 12, 2026

(54) CONTENT RECEIVER MANAGEMENT OF A LOCAL CATALOG OF METADATA FOR LOCALLY RECORDED CONTENT PROGRAMS

(71) Applicant: DISH Network L.L.C., Englewood, CO (US)

(72) Inventor: John Huynh, Denver, CO (US)

(21) Appl. No.: 19/203,916

(22) Filed: May 9, 2025

(51) Int. Cl. H04N 21/83; H04N 21/462

(52) U.S. Cl. CPC H04N 21/83; H04N 21/462

(57) ABSTRACT

Systems and methods for a content receiver to maintain a local catalog of metadata entries for content programs that are locally recorded by the content receiver. In response to a content program being locally recorded, the content receiver obtains metadata for the content program from a global catalog of metadata for content programs identified in an electronic program guide. If the local catalog does not include an entry for the content program, then an entry is generated in the local catalog and includes the metadata obtained from the global catalog. If the local catalog includes the entry for the content program, then the entry is updated based on the metadata obtained from the global catalog. When a new global catalog is received, at least one entry in the local catalog is updated with metadata from the new global catalog.

### BACKGROUND

Content receivers, such as set-top-boxes, enable people watch television in a variety of conditions, including different locations and times. Many content receivers record or store content programs locally on the content receiver to enable user to consume the content programs at a later date. For example, many users record a series of content programs over many weeks, and sometimes years. But searching these locally recorded content programs can become inaccurate as the series progresses and changes over time. It is with respect to these and other considerations that the embodiments described herein have been made.

### BRIEF SUMMARY

Briefly, embodiments are directed to systems and methods for generating and maintaining a local catalog of metadata entries for content programs that are locally recorded by a content receiver. When content programs are locally recorded, the content receiver searches a global catalog of metadata for metadata associated with those content programs. The content receiver generates or updates entries in the local catalog to include the associated metadata. When a new global catalog is received, the local catalog is updated with updated or additional metadata from the new global catalog. The global catalog and the local catalog are then used to generate a search index, which enables a user to find content programs that are currently being aired, content programs that are to air in the future, and locally recorded content programs. If only the global catalog is used to generate the search index, then locally recorded content programs may be unsearchable if the global catalog does not include those content programs or if the metadata has changed. Generating and maintaining the local catalog enables the content receiver to continue to index metadata from the locally recorded content programs.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for where a content receiver maintains a local catalog of metadata for content programs locally recorded by the content receiver in accordance with embodiments described herein.

FIG. 2 shows a block diagram of a system for maintaining a local catalog of metadata for locally recorded content programs in accordance with embodiments described herein.

FIGS. 3A-3B illustrate a logical flow diagram showing one embodiment of a process for maintaining a local catalog of metadata for locally recorded content programs in accordance with embodiments described herein.

FIG. 4 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

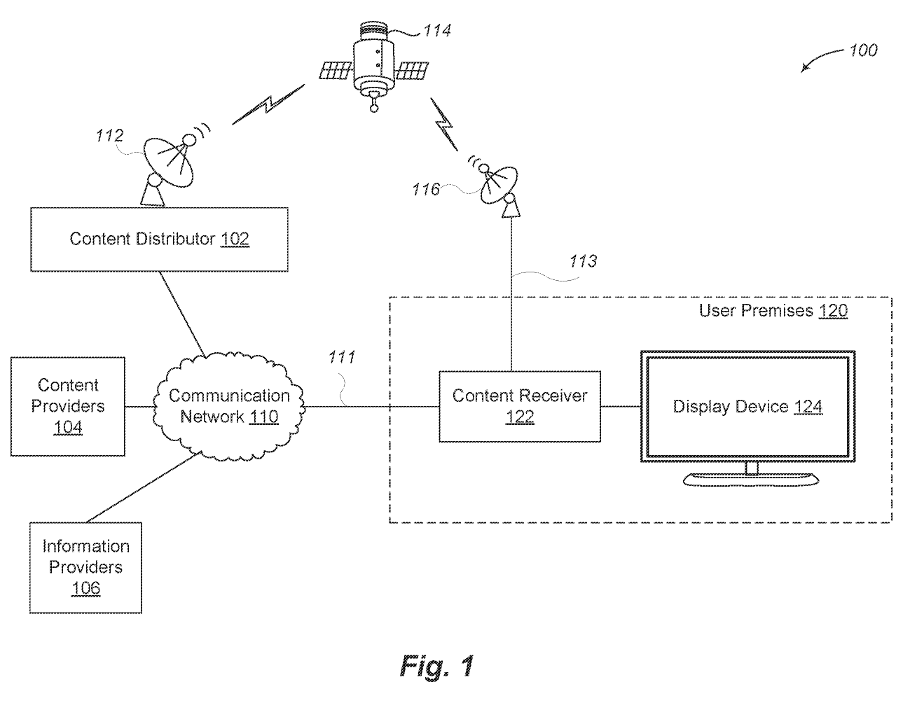

FIG. 1 illustrates a context diagram of an environment 100 for where a content receiver maintains a local catalog of metadata for content programs locally recorded by the content receiver in accordance with embodiments described herein. Environment 100 includes content providers 104, information providers 106, content distributor 102, communication network 110, and user premises 120.

User premises 120 includes a content receiver 122 and a display device 124. The user premises 120 may also include an audio output device (not separately illustrated). Examples of the user premises 120 may be a house, apartment, hotel room, senior living environment, hospital room, etc.

The content receiver 122 is a computing device that receives content for output via display device 124 on the user premises 120. Examples of content receiver 122 may include, but are not limited to, a set-top box, a cable connection box, a computer, television receiver, smart phone, tablet computer, laptop computer, desktop computer, or other computing device that receives content for presentation to a user. Accordingly, the content receiver 122 and the display device 124 may be integrated into a single computing device in some embodiments. Moreover, the content receiver 122 and the display device 124 not be limited to the user premises 120. The display device 124 may be any kind of content display device, such as, but not limited to a television, monitor, projector, or other display device capable of receiving content from the content receiver 122 for output to a user. The content may include audiovisual content that is provided or distributed by content distributor 102. The content may be referred to as the content programs or program content, which may include movies, sitcoms, reality shows, talk shows, game shows, documentaries, infomercials, news programs, sports programs, songs, audio tracks, albums, or the like.

As described herein, the content receiver 122 receives content and a global catalog of metadata for that content. The content receiver 122 is configured to generate, maintain, and manage a local catalog based on content programs that are locally recorded by the content receiver 122. As described herein, locally recording a content program includes the content receiver 122 itself recording and storing the content program or instructing another computing device to record and store the content program for the content receiver 122. The local catalog is a data structure with entries for each locally recorded content program. The entries in the local catalog can be updated based on updated metadata from newly received global catalogs for the corresponding locally recorded content programs. The content receiver 122 can also generate a search index based on the global catalog and the local catalog so that the user can more easily search for or identify locally recorded content programs.

For example, assume the user initiates the content receiver 122 to record a television series called “Show ABC.” When the initial episode is locally recorded by the content receiver 122, the content receiver 122 searches a current global catalog to obtain metadata associated with the initial episode of Show ABC. As discussed herein, the global catalog may include metadata for each content program identified in a current electronic program guide. Examples of such metadata may include a cast list, episode information, series information, etc. The obtained metadata is stored in a local catalog maintained by the content receiver 122. Over time, the content receiver 122 receives new, updated, or current global catalogs as the electronic program guide changes, such as daily or upon request. If the new global catalog includes new or updated metadata for “Show ABC,” then the local catalog is updated to include this updated metadata. The local catalog and the global catalog can be indexed for searching by the user. In this way, if a new actor joins “Show ABC” mid-season and was not in the initial episode, then the user can still find the initial episode recorded by the content receiver 122 when searching for the new actor.

The following briefly discusses additional example components in environment 100. In various embodiments, the content distributor 102 provides content to the content receiver 122. The content distributor 102 may receive a plurality of different content from one or more content providers 104, one or more information providers 106, or a combination thereof. The content distributor 102 provides content and supplemental content, whether obtained from content provider 104 or the data from information provider 106, to a user or viewer through a variety of different distribution mechanisms. For example, in some embodiments, content distributor 102 may provide the content and data to a user’s content receiver 122 directly through communication network 110 on link 111. In other embodiments, the content may be sent through uplink 112, which goes to satellite 114 and back to downlink station 116 that may also include a head end (not shown). The content is then sent to an individual content receiver 122 of a user or viewer at user premises 120 via link 113.

Typically, content providers 104 generate, aggregate, and/or otherwise provide content that is provided to one or more users. Sometimes, content providers are referred to as “channels” or “stations.” Examples of content providers 104 may include, but are not limited to: film studios; television studios; network broadcasting companies; independent content producers, such as AMC, HBO, Showtime, or the like; radio stations; or other entities that provide content for user consumption. A content provider may also include individuals that capture personal or home videos and distribute these videos to others over various online media-sharing websites or other distribution mechanisms. In some embodiments, the content may also include commercials or other television or radio advertisements. It should be noted that the commercials or other advertisements may be added to the program content by the content providers 104 or the content distributor 102.

In at least one embodiment, information provider 106 creates and distributes data or other information that describes or supports content. Generally, this data is related to the program content provided by content provider 104. For example, this data may include metadata, program name, closed-caption authoring and placement within the program content, timeslot data, pay-per-view and related data, or other information that is associated with the program content. Accordingly, the information provider 106 may generate the global catalog that is provided to the content receiver 122, such as directly or via content distributor 102. In some embodiments, a content distributor 102 may combine or otherwise associate the data from information provider 106 and the program content from content provider 104, which may be referred to as the distributed content or more generally as content. However, other entities may also combine or otherwise associate the program content and other data together.

In at least one embodiment, communication network 110 is configured to couple various computing devices to transmit content/data from one or more devices to one or more other devices. For example, communication network 110 may be the Internet, X.25 networks, or a series of smaller or private connected networks that carry the content. Communication network 110 may include one or more wired or wireless networks, which may include cellular networks.

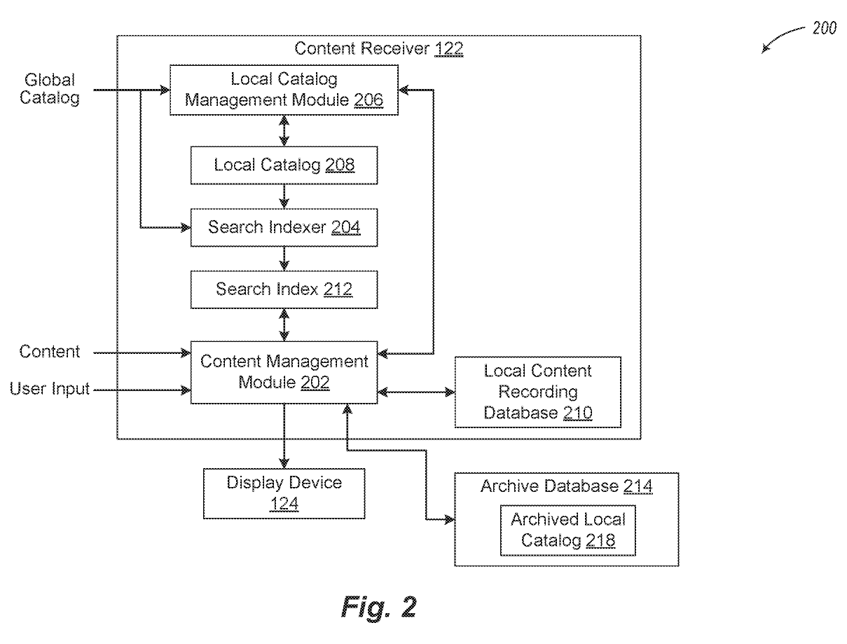

FIG. 2 shows a block diagram of a system 200 for maintaining a local catalog of metadata for locally recorded content programs in accordance with embodiments described herein. System 200 includes a content receiver 122 and a display device 124, similar to what is shown in FIG. 1.

The content receiver 122 includes a content management module 202, a search indexer 204, and a local catalog management module 206. The local catalog management module 206 is configured to generate and update a local catalog 208 as content programs are locally recorded, such as in local content recording database 210, and as new or updated global catalogs are received by the content receiver 122. As described herein, the local catalog management module 206 can obtain locally recorded content program metadata from the global catalog to generate, update, or modify entries in the local catalog for the same locally recorded content programs.

The search indexer 204 may be configured to generate a search index 212 from a current or most-recently received global catalog and the local catalog 208. The search indexer 204 may generate or update the search index when a new or updated global catalog is received by the content receiver 122, in response to the local catalog 208 being generated or updated, or at other times. The search index 212 includes a searchable data structure of metadata and their association with content programs (locally recorded content programs, currently airing or showing content programs, content programs identified in the electronic program guide, or other accessible content).

The content management module 202 is configured to receive content, such as from content distributor 102 in FIG. 1, and present the content to a user via display device 124. The content management module 202 may also be configured to receive input from the user. In some embodiments, the user can input a request to locally record content programs. In response to receiving the user’s request, the content management module 202 may be configured to record and store a copy of that content program in the local content recording database 210 when the content program is received or accessible to the content receiver 122. The content management module 202 can also notify the local catalog management module 206 of a content program being locally recorded. In other embodiments, the user can input one or more search terms. The content management module 202 may query the search index 212 using the search terms to identify associated content programs.

In some embodiments, the content management module 202 may move or archive one or more content programs from the local content recording database 210 to a separate or external archive database 214. During archiving, each entry in the local catalog 208 that corresponds to the archived content programs is also stored on in the archive database 214 (optional) as an archived local catalog 218. When the archive database 214 is connected to the content receiver 122, the search indexer 204 can generate the search index 212 from the archived local catalog 218, the global catalog, and the local catalog 208. But when the archive database 214 is not connected to the content receiver 122, then the search indexer 204 does not have access to the archived local catalog 218 and generates the search index 212 from the global catalog and the local catalog 208. In some embodiments, however, the content receiver 122 may store (not illustrated) the archived local catalog 218 so that the search indexer 204 can generate the search index 212 from the archived local catalog 218, the global catalog, and the local catalog 208, even if the archive database 214 is not connected to the content receiver. In such an embodiment, the search index 212 can also include information indicating whether a content program is stored in the local content recording database 210 or in the non-connected archive database 214. As a result, a plurality of separate archive databases could be used, with each having a separate archive local catalog.

Although the content management module 202, the search indexer 204, and the local catalog management module 206 are illustrated as being separate modules, embodiments are not so limited. Rather, the functionality of the content management module 202, the search indexer 204, and the local catalog management module 206 may be performed by a single module or performed by a plurality of modules. As described herein, a processor system may be utilized to perform the embodiments of the content management module 202, the search indexer 204, and the local catalog management module 206.

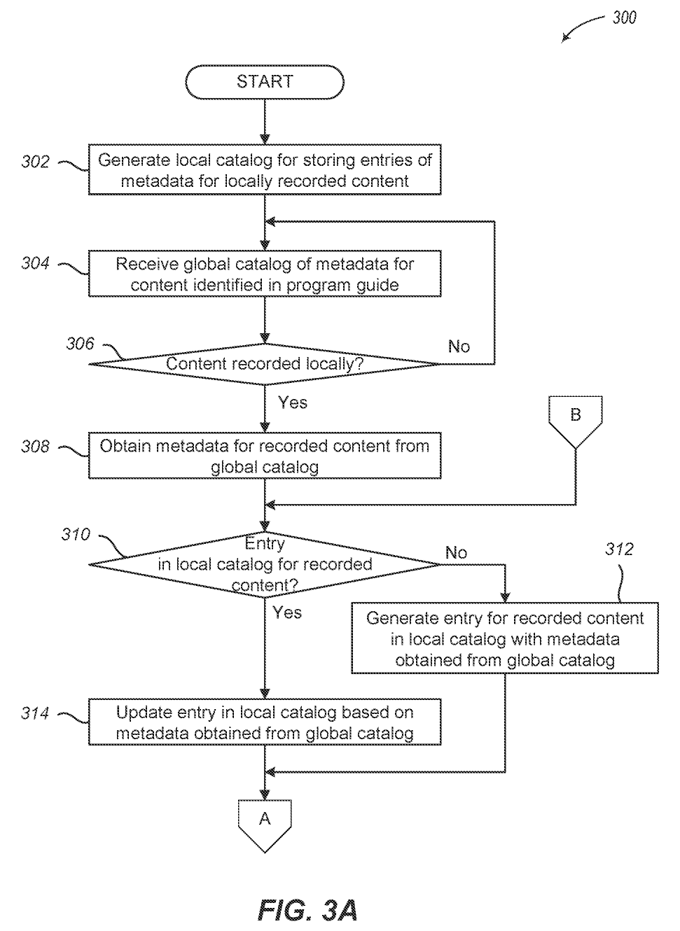

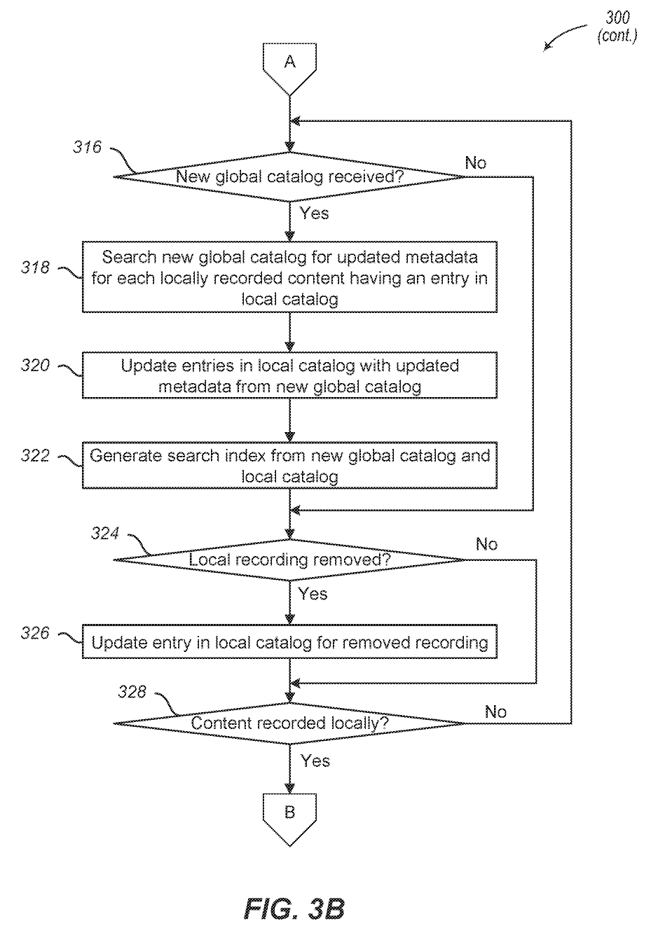

The operation of certain aspects will now be described with respect to FIG. 3A and 3B. FIGS. 3A and 3B illustrate a logical flow diagram showing one embodiment of a process 300 for maintaining a local catalog of metadata for locally recorded content programs in accordance with embodiments described herein. Process 300 may be implemented by one or more processors or executed via circuitry on one or more computing devices, such as content receiver 122 in FIGS. 1 and 2.

Process 300 begins, after a start block in FIG. 3A, at block 302, where a local catalog is generated. The local catalog is a data structure for storing entries of metadata for locally recorded content programs. Generating the local catalog may include provisioning the data structure or computing resources to store the entries. In some embodiments, the content receiver may initially generate or establish an empty local catalog that is to be populated as content programs are locally recorded, such as determined at decision block 306 or decision block 328 in FIG. 3B. In other embodiments, the local catalog may be generated in response to the first program content being locally recorded.

Process 300 proceeds, after block 302, to block 304, where a global catalog of metadata is received. The global catalog includes metadata for content programs that are identified in a current electronic program guide (e.g., an electronic program guide identifying which content programs are available to watch on a given day at a given time for a set time period, such as the next two weeks). In some embodiments, a new global catalog is received at periodic intervals, such as once each day or twice a day. In other embodiments, the global catalog may also be received in response to the content receiver transmitting a request to a server device to receive the global catalog, such as in response to the content receiver being turned on or reset.

The global catalog is a data structure that stores metadata for content programs, which can be searched by the content receiver for specific content programs. As described herein, the content receiver may generate a search index from the global catalog, which can then be searched for search terms input by a user. For example, the global catalog enables a user to search for a content program that is to be aired or broadcast in the future. The metadata includes various information about the content programs currently listed in the electronic program guide. Because content programs can include movies, news broadcasts, television shows, franchise episodes, sports broadcasts, and other types of content, the metadata can include multiple different types of metadata. Examples of metadata may include title, genre category, franchise information, episode information, cast information (e.g., the cast of the current season for a franchise), celebrity appearance information, parental ratings, type of sport, team information, sport conference information, league information, previous sport scores, etc.

Process 300 continues, after block 304, at decision block 306, where a determination is made whether a content program has been locally recorded by the content receiver. In various embodiments, this determination may be triggered by the content receiver locally recording a content program, which may be initiated by a user selecting the content program to be recorded when aired and received by the content receiver. In some embodiments, the locally recorded content program may be a single program (e.g., a movie) or it may be part of a franchise (e.g., a television series) or it may be an event associated with a particular characteristic (e.g., a football game of a particular team, where each game for that team is recorded).

In some embodiments, locally recording a content program may include the content receiver storing a copy of the content program on an internal memory of the content receiver or on an external storage device (e.g., an external hard drive) that is physically connected to the content receiver. In other embodiments, locally recording a content program may include the content receiver instructing a separate and remote server to store a copy of the content program specifically for the content receiver or specifically for the user of the content receiver. If a content program has been locally recorded by the content receiver, then process 300 flows to block 308; otherwise, process 300 loops to block 304 to continue to receive updated global catalogs.

At block 308, metadata for the recorded content program is obtained from the global catalog. In some embodiments, a most recently-received global catalog is searched for metadata associated with the recorded content program upon initiation or completion of the content program being recorded. Because content programs can vary widely from one another, and because some content programs may have more associated metadata compared to other content programs, the metadata obtained from the global catalog may also vary in type and amount.

Process 300 proceeds, after block 308, to decision block 310, where a determination is made whether the local catalog already includes an entry for the recorded content program. In various embodiments, the local catalog may be searched for an entry that corresponds to the recorded content program. In some embodiments, each separate content program may be associated with a unique identifier, which can be stored in the local catalog as the entry identifier. In other embodiments, each separate series or franchise may be associated with a unique identifier, which can be stored in the local catalog as the entry identifier. If the unique identifier for the recorded content program is in the local catalog, then the local catalog includes an entry for the recorded content program. If the local catalog includes an entry for the recorded content program, then process 300 flows to block 314; otherwise, process 300 flows to block 312.

At block 314, the entry in the local catalog is updated based on the metadata obtained from the global catalog. In some embodiments, the previously stored metadata in the local catalog entry is compared to the metadata obtained from the global catalog. If there is a difference between the metadata in the local catalog and the metadata obtained from the global catalog, then the difference in metadata from the global catalog may be added to the entry in the local catalog. In some embodiments, the previously stored metadata in the entry is not removed nor changed during the updating of the entry – rather the local catalog is expanded with metadata from the global catalog. In this way, if there is a change, then the change is noted without altering the previous metadata. For example, if the cast of a television series changes, then the new cast members are added to the local catalog entry, while also maintaining the old cast members. In some other embodiments, the previously stored metadata in the entry may be changed or modified. For example, the local catalog may include an entry for a particular sports team. The global catalog may include the score of a previous game, which can be used to update the local catalog entry for that sports team.

If, at decision block 310, the local catalog does not include an entry for the recorded content program, then process 300 flows to block 311, where an entry is generated in the local catalog for the recorded content program. In various embodiments, the local catalog is modified to add a new entry for the recorded content program, which includes the metadata for the recorded content program that was obtained from the global catalog. As noted above, a unique identifier for the recorded content program may be used as an identifier of the entry in the local catalog for that recorded content program.

After block 312 or after block 314, process 300 proceeds to decision block 316 in FIG. 3B.

At decision block 316, a determination is made whether a new global catalog is received. As discussed herein, a new global catalog may be received at periodic intervals or as requested by the content receiver. If a new global catalog is received, process 300 flows to block 318; otherwise, process 300 flows to decision block 324.

At block 318, the new global catalog is searched for updated metadata for each locally recorded content having an entry in the local catalog. In some embodiments, the global catalog is searched for a content program identifier for each entry in the local catalog. If the content program identifier is found in the global catalog, then the associated metadata for that content program is obtained from the global catalog. To determine if the obtained metadata for a content program is considered updated metadata, the content receiver compares the obtained metadata to the metadata stored in the local catalog for that content program. If there are differences between the obtained metadata and the metadata stored in the local catalog, then the new global catalog includes updated metadata for that content program. If there are no differences between the obtained metadata and the metadata stored in the local catalog, then the new global catalog does not include updated metadata for that content program.

Process 300 proceeds, after block 318, to block 320, where one or more entries in the local catalog are updated with the updated metadata from the new global catalog. In various embodiments, block 320 may employ embodiment of block 314 to update each entry in the local catalog with the updated metadata. For example, for each entry in the local catalog where updated metadata is identified, those entries may be modified to add the difference between the obtained metadata and the metadata stored in the local catalog.

Process 300 continues, after block 320, at block 322, where a search index is generated from the new global catalog and the local catalog. In various embodiments, the search index is generated by parsing the metadata from the global catalog and the local catalog into a searchable data structure.

Process 300 proceeds, after block 322, to decision block 324, where a determination is made whether a local recording of a content program has been removed. In some embodiments, this determination may be made in response to the user manually selecting to delete or remove a locally recorded content program. In other embodiments, this determination may be made in response to a locally recorded content program being automatically deleted or removed from the content receiver, such as in response to the content receiver reaching a maximum data storage capacity. In yet other embodiments, this determination is made in response to the content program being archived on another storage device. If a local recording of a content program has been removed, then process 300 flows to block 326; otherwise, process 300 flows to decision block 328.

At block 326, the entry in the local catalog that corresponds to the locally recorded content program that was removed is updated for removal from the local catalog. In various embodiments, the entry may be automatically deleted from the local catalog in response to the content program being removed. In other embodiments, a flag associated with the entry may be marked for removal. The content receiver can then remove flagged entries at a later time, such as during the next bootup of the content receiver or at a particular time when the content receiver is idle.

Process 300 proceeds, after block 326, to decision block 328, where a determination is made whether a content program has been recorded locally. In various embodiments, decision block 328 may employ embodiment of decision block 306 to determine if a content program was recorded locally by the content receiver. If a content program has not been recorded locally, then process 300 loops to decision block 316 to determine if a new global catalog has been received. If a content program has been recorded locally, then process 300 loops to decision block 310 in FIG. 3A to determine if the local catalog includes an entry for the content program.

In some embodiments, parts of process 300 may be performed separately from one another. For example, a first process may be performed to determine if a content program is recorded locally and update the local catalog accordingly, and a second process may be performed to monitor new global catalogs as they are received and update the local catalog accordingly. Moreover, in some embodiments, process 300 may generate the search index at other times in addition to when a new global catalog is received.

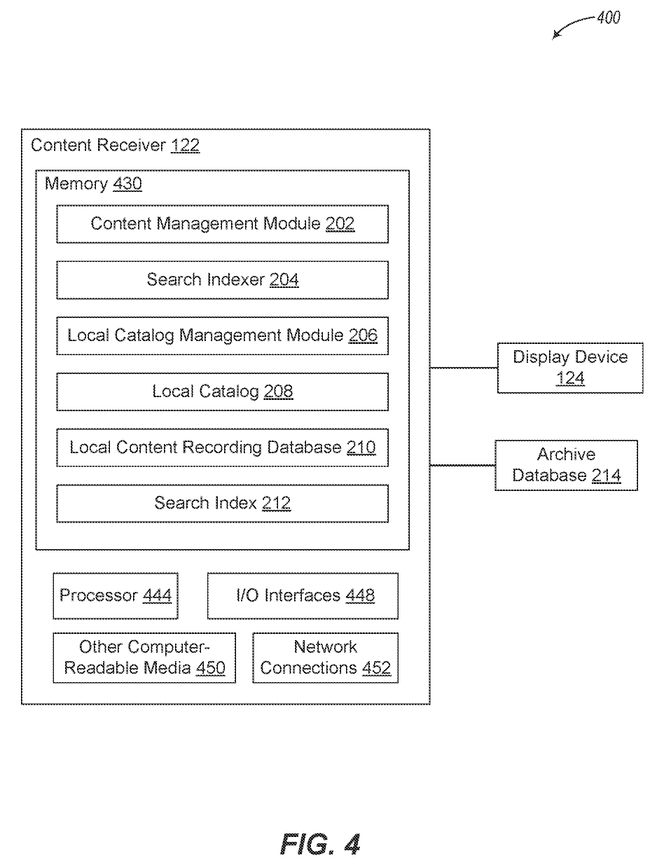

FIG. 4 shows a system diagram that describe various implementations of computing systems for implementing embodiments described herein. System 400 includes content receiver 122, display device 124, and optionally archive database 214. The display device 124 is configured to display or present a content to a user of the content receiver 122. And the archive database 214 is configured to store archived copies of locally recorded content programs.

The content receiver 122 receives and output content to a user. The content receiver 122 generates and maintains a local catalog of metadata for locally recorded content programs, as described herein. One or more special-purpose computing systems may be used to implement content receiver 122. Accordingly, various embodiments described herein may be implemented in software, hardware, firmware, or in some combination thereof. Content receiver 122 may include memory 430, processor 444, I/O interfaces 448, other computer-readable media 450, and network connections 452.

Memory 430 may include one or more various types of non-volatile and/or volatile storage technologies. Examples of memory 430 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 430 may be utilized to store information, including computer-readable instructions that are utilized by processor 444 to perform actions, including embodiments described herein.

Processor 444 includes one or more processors, one or more processing units, programmable logic, circuitry, or one or more other computing components that are configured to perform embodiments described herein or to execute computer instructions to perform embodiments described herein. In some embodiments, a processor system of the content receiver 122 may include a single processor 444 that operates individually to perform actions. In other embodiments, a processor system of the content receiver 122 may include a plurality of processors 444 that operate to collectively perform actions, such that one or more processors 444 may operate to perform some, but not all, of such actions. Reference herein to “a processor system” of the content receiver 122 refers to one or more processors 444 that individually or collectively perform actions. And reference herein to “the processor system” of the content receiver 122 refers to 1) a subset or all of the one or more processors 444 comprised by “a processor system” of the content receiver 122 and 2) any combination of the one or more processors 444 comprised by “a processor system” of the content receiver 122 and one or more other processors 444.

Memory 430 may have stored thereon content management module 202, search indexer 204, and local catalog management module 206, as described herein. The memory 430 may also store local catalog 208, local content recording database 210, and search index 212, as described herein. The memory 430 may also store other data (not illustrated), including programs, operating systems, or other information or data.

Network connections 452 are configured to communicate with other computing devices. I/O interfaces 448 may include a keyboard, audio interfaces, video interfaces, or the like, which may enable to the content receiver 122 to output the content via the display device. Other computer-readable media 450 may include other types of stationary or removable computer-readable media, such as removable flash drives, external hard drives, or the like.

The following is a summarization of the claims as originally filed.

A method may be performed by a content receiver and may be summarized as comprising: generating a local catalog that stores entries of metadata for content programs that are locally recorded by the content receiver; receiving a global catalog of metadata for content programs identified in an electronic program guide; in response to a content program being locally recorded: obtaining metadata for the content program from the global catalog; if the local catalog does not include an entry for the content program, generating, by the content receiver, the entry in the local catalog for the content program to include the metadata for the content program obtained from the global catalog; and if the local catalog includes the entry for the content program, updating, by the content receiver, the entry in the local catalog for the content program with the metadata for the content program obtained from the global catalog; receiving a new global catalog of updated metadata for content programs identified in an updated electronic program guide; and updating at least one entry in the local catalog with updated metadata from the new global catalog.

The method may further comprise: searching the new global catalog for the updated metadata for each locally recorded content program having an entry in the local catalog.

The method may update the at least one entry in the local catalog with the updated metadata from the new global catalog by comprising: adding new information from the new global catalog to the at least one entry in the local catalog.

The method may further comprise: indexing the global catalog and the local catalog to be searchable by a user of the content receiver.

The method may further comprise: generating a search index from the new global catalog and the local catalog.

The method may further comprise: receiving at least one search term from the user; querying the search index for the at least one search term; in response to the at least one search term being found in the search index, selecting a corresponding entry in the local catalog; and providing an identifier of the content program for the corresponding entry in the local catalog.

The method may further comprise: storing an archive of the content programs that are locally recorded on the content receiver; and storing the local catalog on the separate device with the archive.

The method may further comprise: receiving an indication of a locally recorded content program being deleted; and removing the entry for the locally recorded content program from the local catalog.

A content receiver may be summarized as comprising: a memory configured to store computer instructions; and a processor system configured to execute the computer instructions to: receive a global catalog of metadata for content programs identified in an electronic program guide; in response to a content program being locally recorded: obtain metadata for the content program from the global catalog; and add or update an entry in a local catalog for the content program with the metadata for the content program obtained from the global catalog; receive a new global catalog of updated metadata for content programs identified in an updated electronic program guide; and update at least one entry in the local catalog with updated metadata from the new global catalog.

The processor system of the content receiver may be configured to further execute the computer instructions to: search the new global catalog for the updated metadata for each locally recorded content program having an entry in the local catalog.

The processor system of the content receive may update the at least one entry in the local catalog with the updated metadata from the new global catalog is by being configured to further execute the computer instructions to: add new information from the new global catalog to the at least one entry in the local catalog.

The processor system of the content receiver may be configured to further execute the computer instructions to: index the global catalog and the local catalog to be searchable by a user of the content receiver.

The processor system of the content receiver may be configured to further execute the computer instructions to: index the new global catalog and the local catalog to be searchable by a user of the content receiver.

The processor system of the content receiver may be configured to further execute the computer instructions to: generate a search index from the new global catalog and the local catalog; receive at least one search term from the user; query the search index for the at least one search term; in response to the at least one search term being found in the search index, select a corresponding entry in the local catalog; and provide an identifier of the content program for the corresponding entry in the local catalog.

The processor system of the content receiver may be configured to further execute the computer instructions to: store, on a separate device, an archive of the content programs that are locally recorded on the content receiver; and store the local catalog on the separate device with the archive.

The processor system of the content receiver may be configured to further execute the computer instructions to: receive an indication of a locally recorded content program being deleted; and remove the entry for the locally recorded content program from the local catalog.

The processor system of the content receiver may be configured to further execute the computer instructions to: generate the local catalog for storing entries of metadata for content programs that are locally recorded by the content receiver.

A non-transitory computer-readable storage medium may be summarized as storing instructions that, when executed by a processor in a computing system, cause the processor to perform actions, the actions comprising: receiving a first global catalog of first metadata for first content programs identified in a first electronic program guide; locally storing a content program from the electronic program guide; obtaining metadata for the content program from the first global catalog; adding or updating an entry in a local catalog for the content program with the obtained metadata; receiving a second global catalog of second metadata for second content programs identified in a second electronic program guide; updating at least one entry in the local catalog with second metadata from the second global catalog; and enabling a user to search the local catalog for content programs.

The non-transitory computer-readable storage medium may store instructions that, when executed by the processor, cause the processor to perform further actions, the further actions comprising: searching the second global catalog for the second metadata for each locally stored content program having an entry in the local catalog.

The non-transitory computer-readable storage medium may store instructions that, when executed by the processor to enable the user to search the local catalog for content programs, cause the processor to perform further actions, the further actions comprising: indexing the second global catalog and the local catalog.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
generating, by a content receiver, a local catalog that stores entries of metadata for content programs that are locally recorded by the content receiver;
receiving, by the content receiver, a global catalog of metadata for content programs identified in an electronic program guide;
in response to a content program being locally recorded:
obtaining, by the content receiver, metadata for the content program from the global catalog;
if the local catalog does not include an entry for the content program, generating, by the content receiver, the entry in the local catalog for the content program to include the metadata for the content program obtained from the global catalog; and
if the local catalog includes the entry for the content program, updating, by the content receiver, the entry in the local catalog for the content program with the metadata for the content program obtained from the global catalog;
receiving, by the content receiver, a new global catalog of updated metadata for content programs identified in an updated electronic program guide; and
updating, by the content receiver, at least one entry in the local catalog with updated metadata from the new global catalog.

2. The method of claim 1, further comprising:
searching, by the content receiver, the new global catalog for the updated metadata for each locally recorded content program having an entry in the local catalog.

3. The method of claim 1, wherein updating the at least one entry in the local catalog with the updated metadata from the new global catalog comprises:
adding, by the content receiver, new information from the new global catalog to the at least one entry in the local catalog.

4. The method of claim 1, further comprising:
indexing, by the content receiver, the global catalog and the local catalog to be searchable by a user of the content receiver.

5. The method of claim 1, further comprising:
generating, by the content receiver, a search index from the new global catalog and the local catalog.

6. The method of claim 5, further comprising:
receiving, by the content receiver, at least one search term from the user;
querying, by the content receiver, the search index for the at least one search term;
in response to the at least one search term being found in the search index, selecting, by the content receiver, a corresponding entry in the local catalog; and
providing, by the content receiver, an identifier of the content program for the corresponding entry in the local catalog.

7. The method of claim 1, further comprising:
storing, on a separate device, an archive of the content programs that are locally recorded on the content receiver; and
storing, by the content receiver, the local catalog on the separate device with the archive.

8. The method of claim 1, further comprising:
receiving, by the content receiver, an indication of a locally recorded content program being deleted; and
removing, by the content receiver, the entry for the locally recorded content program from the local catalog.

9. A content receiver, comprising:
a memory configured to store computer instructions; and
a processor system configured to execute the computer instructions to:
receive a global catalog of metadata for content programs identified in an electronic program guide;
in response to a content program being locally recorded:
obtain metadata for the content program from the global catalog; and
add or update an entry in a local catalog for the content program with the metadata for the content program obtained from the global catalog;
receive a new global catalog of updated metadata for content programs identified in an updated electronic program guide; and
update at least one entry in the local catalog with updated metadata from the new global catalog.

10. The content receiver of claim 9, wherein the processor system is configured to further execute the computer instructions to:
search the new global catalog for the updated metadata for each locally recorded content program having an entry in the local catalog.

11. The method of claim 1, wherein the processor system updates the at least one entry in the local catalog with the updated metadata from the new global catalog is by being configured to further execute the computer instructions to:
add new information from the new global catalog to the at least one entry in the local catalog.

12. The content receiver of claim 9, wherein the processor system is configured to further execute the computer instructions to:
index the global catalog and the local catalog to be searchable by a user of the content receiver.

13. The content receiver of claim 9, wherein the processor system is configured to further execute the computer instructions to:
index the new global catalog and the local catalog to be searchable by a user of the content receiver.

14. The content receiver of claim 9, wherein the processor system is configured to further execute the computer instructions to:
generate a search index from the new global catalog and the local catalog;
receive at least one search term from the user;
query the search index for the at least one search term;
in response to the at least one search term being found in the search index, select a corresponding entry in the local catalog; and
provide an identifier of the content program for the corresponding entry in the local catalog.

15. The content receiver of claim 9, wherein the processor system is configured to further execute the computer instructions to:
store, on a separate device, an archive of the content programs that are locally recorded on the content receiver; and
store the local catalog on the separate device with the archive.

16. The content receiver of claim 9, wherein the processor system is configured to further execute the computer instructions to:
receive an indication of a locally recorded content program being deleted; and
remove the entry for the locally recorded content program from the local catalog.

17. The content receiver of claim 9, wherein the processor system is configured to further execute the computer instructions to:
generate the local catalog for storing entries of metadata for content programs that are locally recorded by the content receiver;

18. A non-transitory computer-readable storage medium that stores instructions that, when executed by a processor in a computing system, cause the processor to perform actions, the actions comprising:
receiving a first global catalog of first metadata for first content programs identified in a first electronic program guide;
locally storing a content program from the electronic program guide;
obtaining metadata for the content program from the first global catalog;
adding or updating an entry in a local catalog for the content program with the obtained metadata;
receiving a second global catalog of second metadata for second content programs identified in a second electronic program guide;
updating at least one entry in the local catalog with second metadata from the second global catalog; and
enabling a user to search the local catalog for content programs.

19. The non-transitory computer-readable storage medium of claim 18, wherein the instructions, when executed by the processor, cause the processor to perform further actions, the further actions comprising:
searching the second global catalog for the second metadata for each locally stored content program having an entry in the local catalog.

20. The non-transitory computer-readable storage medium of claim 18, wherein the instructions, when executed by the processor to enable the user to search the local catalog for content programs, cause the processor to perform further actions, the further actions comprising:
indexing the second global catalog and the local catalog.
